(19) United States
(12) Patent Application Publication
(10) Pub. No.: US 2010/0188479 A1
(43) Pub. Date: Jul. 29, 2010

(54) PANORAMIC HEAD FOR PHOTOGRAPHIC AND VIDEO-PHOTOGRAPHIC EQUIPMENT

(76) Inventors: Roberto Bordignon, Cassola (IT); Diego Grapiglia, Marostica (IT); Hem Sudhana, Cassola (IT); Stelvio Zarpellon, Bassano del Grappa (IT)

Correspondence Address: CASTELLANO PLLC, P.O. Box 1555, Great Falls, VA, 22066, US

(21) Appl. No.: 12/669,480

(22) PCT Filed: Jul. 9, 2008
(86) PCT No.: PCT/EP2008/058934

§ 371 Date: Jan. 16, 2010

(30) Foreign Application Priority Data
Jul. 20, 2007 (IT) PD 2007 A 000248

(51) Int. Cl. H04N 5/225; H04N 5/262

(52) U.S. Cl. 348/36; 348/374; 348/E05.028; 348/E05.051

(57) ABSTRACT

A panoramic head (1; 80) for photographic and video-photographic equipment includes a first (2), a second (21; 81), and at least a third support member (40),which are articulated in series with one another respectively about a first, a second and at least a third positioning axis (P, T, L), respectively panoramic (P), azimuthal (T), and level (L), so as to be positionable in an adjustable manner about the axes (P, T, L) for the three-dimensional positioning of the optical axis (X) of photographic or video-photographic equipment mounted on the third member (40). At least one of the second (21; 81) and third members (40) comprises an annular support (40; 81) such that the member borne on the annular support (40; 81) is rotatable about the third axis (L).

### TECHNICAL FIELD

The subject of the present invention is a panoramic head for photographic and video-photographic equipment of the type including the characteristics mentioned in the preamble of the main claim.

### BACKGROUND ART

Heads including such characteristics are commercially known for taking, among other things, panoramic photographs in which a sequence of angularly contiguous photographic shots as a whole depicts a relatively expansive subject. Such known heads basically comprise three support members articulated with one another in series, one upon the other, in such a way that the first is rotatable about an axis (known as panoramic or “pan”) generally perpendicular to the plane of reference (or to the horizontal plane), the second is rotatable with respect to the first about a second axis (known as azimuthal or “tilt”) parallel to the plane of reference and perpendicular to the preceding one, and the third is orientable about a third axis (known as “level”) perpendicular to the two preceding ones. These known heads, however, have some drawbacks which do not make them very easy to operate.

A first drawback lies in the fact that the orientability of the third member is normally rather limited. The tendency is to limit such orientability to only two positions, orthogonal to each other, known as panorama and portrait. This is a first unacceptable limitation of these heads and also in turn includes further drawbacks. In one of such positions, in fact, the photographic apparatus is supported in a cantilevered manner on the tripod, potentially compromising its equilibrium, when this is in any case already precarious, as in the case of difficult positioning on steeply sloping terrain. Normally, however, the optical axis of the apparatus does not coincide for all positions with the third (level) axis, thus implying on the one hand possible unbalancing of the tripod and on the other hand non-uniform couples for the actuation of the head, thereby affecting, once again negatively, the homogeneity of operation of the head, in particular when it is motor-driven.

### DISCLOSURE OF THE INVENTION

The technical problem underlying the present invention is that of providing a panoramic head structurally and functionally designed to remedy the drawbacks mentioned with reference to the prior art cited.

This problem is solved by the invention by means of a panoramic head produced according to the following claims.

### BRIEF DESCRIPTION OF THE DRAWINGS

The characteristics and advantages of the invention will become clearer from the detailed description of a preferred, but not exclusive, exemplary embodiment thereof, illustrated by way of non-limiting example with reference to the appended drawings, in which:

FIG. 1 is a diagrammatic perspective view of the panoramic head of the present invention;

FIG. 2 is a front view of the head of FIG. 1;

FIG. 3 is a diagrammatic cross-sectional view of the head of FIG. 1;

FIG. 4 is a detail, on an enlarged scale, of FIG. 3;

FIGS. 5 and 6 are respectively a side view and a sectional view along the line B-B in FIG. 5 of the head of the preceding figures;

FIG. 7 is a sectional view along the line A-A of FIG. 2;

FIG. 8 is a sectional view along the line C-C of FIG. 5;

FIG. 9 is a more detailed view of a detail of FIG. 7;

FIG. 10 is a diagrammatic front view of an alternative embodiment of the head of the present invention.

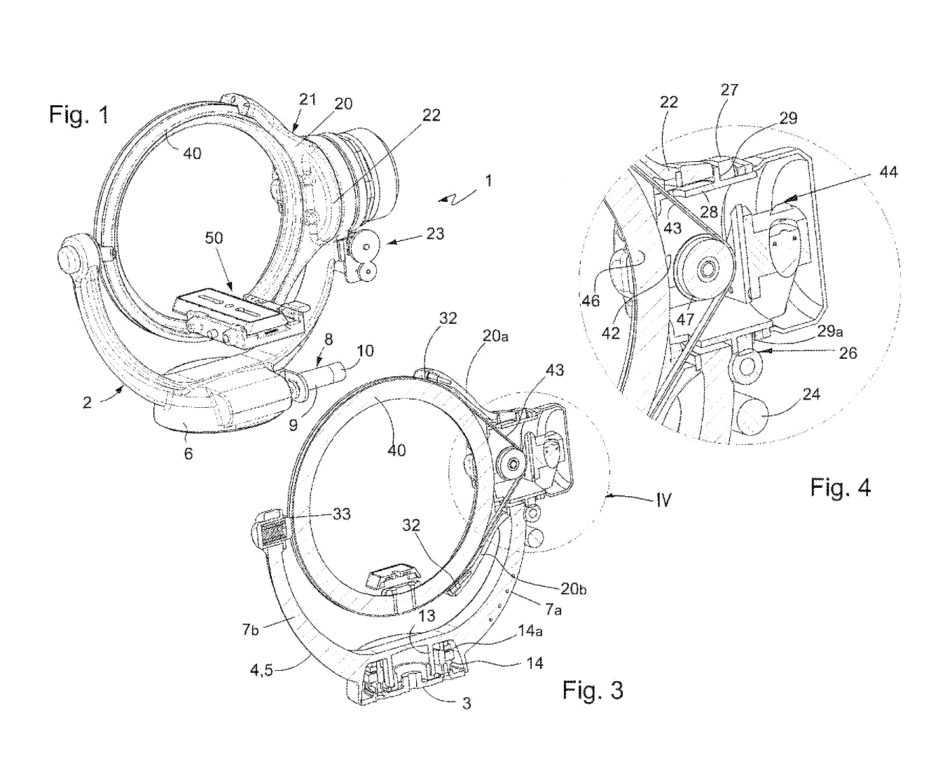

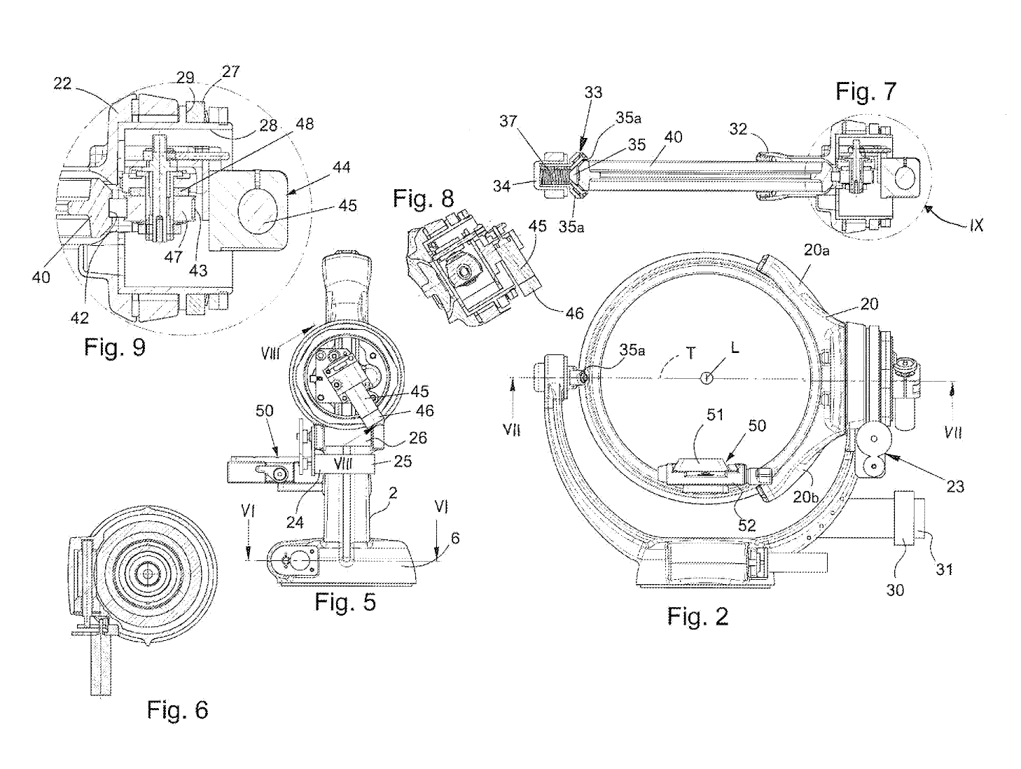

### BEST MODE OF CARRYING OUT THE INVENTION

In the figures, the reference 1 indicates as a whole a panoramic head for a photographic or video-photographic apparatus, not shown, capable of being mounted on the head 1 at a slide 2 in such a way as to be fitted with an optical axis X thereof positioned relative to the head 1 as described in more detail hereinafter.

The head 1 comprises a first support member 2 including a fixed element 3, so named in that it is intended to be fixed to a support such as a photographic tripod, not shown, and a movable element 4. The movable element 4 itself comprises a first fork 5 articulated by a base 6 thereof, intermediate between two opposed first prongs 7a, 7b, on the fixed element 3 so as to be able to rotate about a first axis P, known as panoramic.

The rotation about the axis P is controlled via a motor-driven micrometric control actuating means, indicated as a whole by 8, including an electric motor 9, with a corresponding encoder 10, acting on an endless speed reduction means 11, the gearwheel 12 of which is secured in rotation to a collar 13 of the base 6 with the interposition of a clutch 14 loaded by a spring means 14a. In this way, any possible accidental locking of the first member is prevented from causing damage to the head or to the photographic apparatus mounted thereon, and it is further possible to manually actuate the rotation of the first support member 2 in case of necessity, or when it is desired to position the head 1 rapidly, although approximately.

Mounted at the free end of the prong 7a is a second fork 20 of a second support member indicated as a whole by 21. The fork 20 is rotatable about an axis T (known as “tilt axis”) for the adjustment of the azimuthal positioning (understood as the elevation with respect to the horizon) of the head 1. For this reason, this axis will be referred to also by the term azimuthal axis. The prong 7a in this case functions as a fixed element and the second fork as a movable element of the second support member. The second fork also comprises two prongs 20a, 20b extending from a base 22. The orientation of the second fork 20 with respect to the axis T is also in this case effected by means of a motor-driven micrometric control actuating means, indicated as a whole by 23, including an electric motor 24, with a corresponding encoder 25, acting on an endless screw speed reducer 26, the gearwheel 27 of which is secured in rotation to a collar 28 of the base 22 with the interposition of a clutch 29 resiliently loaded by a springing 29a. In this way, any accidental locking also of the second member is prevented from causing damage to the head or to the photographic apparatus mounted thereon, and it is further possible to manually actuate the rotation of the second support member 21 in case of necessity, or when it is desired to rapidly, although approximately, position the head 1.

It will further be noted that each part of the electrical actuating means 23 subject to the electrical supply is mounted on board the first prong 7a such that the actuating means both of the first and the second support member 2, 21 are borne on the first fork 5. Likewise mounted on that fork are a supply battery 30 and a remote control unit 31 (for example radio-frequency) for the head 1. In this way the result obtained is that the major part of the cables for the supply and control of the head 1, including the cables for the supply circuit of the electric motors and those of the feedback circuit that are connected to the encoder, are movable together with the first support member, thus permitting complete rotations about the pan axis P without kinking of the aforesaid cables and without complex and not very reliable stratagems such as sliding contacts and the like.

A third support member, indicated as a whole by 40, in the shape of an annular centre bearing, is supported on the second member 21 via two support points provided at the free ends of the prongs 20a, 20b, for example with a pair of V-shaped bearings 32, as well as at a third support point 33 mounted at the free end of the prong 7b of the first fork. The third point 33 comprises a bush 34 rotatable about the axis T, and a sprung support 35 having two V-shaped bearings 35a, with a springing formed by a spring 37 which presses the third point 33 against the centre bearing 40.

The centre bearing 40 has on the perimeter a track 42 for the engagement of a belt 43 which is actuated by a motor-driven micrometric controlled actuating means, indicated as a whole by 44, including an electric motor 45, with a corresponding encoder 46, acting on a wheel 47 on which the belt 43 is closed with the interposition of a clutch 48. The third support member is orientable about the axis L of the centre bearing 40, indicated hereinafter as the level axis for a rotation of more than 360° (preferably greater than 90°).

On the inner perimeter of the centre bearing 40, a sliding support 50 for the desired optical, photographic or video-photographic equipment is mounted. The support 50 comprises a slide 51 displaceable in an adjustable manner along a guide 52 parallel to the axis L for the purpose of balancing as well as possible the optical equipment mounted on the slide. The relative positioning is such that the equipment mounted on the head 1, besides being always in a substantially barycentric position on the head, has its optical axis substantially coinciding with the level axis so that the equipment can be displaced from the panoramic position, for example horizontal, to a portrait position, for example rotated through 90°, without losing either the framing or the focusing of the subject.

The operation of the head 1 is as follows.

First of all, owing to the frictioning of the control of actuation of the three positioning axes P, T, L it is possible to manually position the head, at least approximately, and then proceed to fine adjustment of the desired positioning via the micrometric controls. The latter, owing to the great reduction in the transmission ratio and to the closed loop feedback control, permit positioning accuracies of the order of a tenth of a degree, which is particularly important when positioning has to be carried out far from the subject being taken, by means of high enlargement optics.

By actuating each motor in one direction of rotation or in the opposite direction, the movement of the respective support member with respect to the corresponding axis P, L, T is thus obtained either by direct control or by remote control, by means of the signals received from the unit 31.

It is to be understood that the clutches used in the head thus described may be pre-loaded either with a fixed load or with an adjustable load, adding to the respective springs, rings or shims for varying the resilient load thereof.

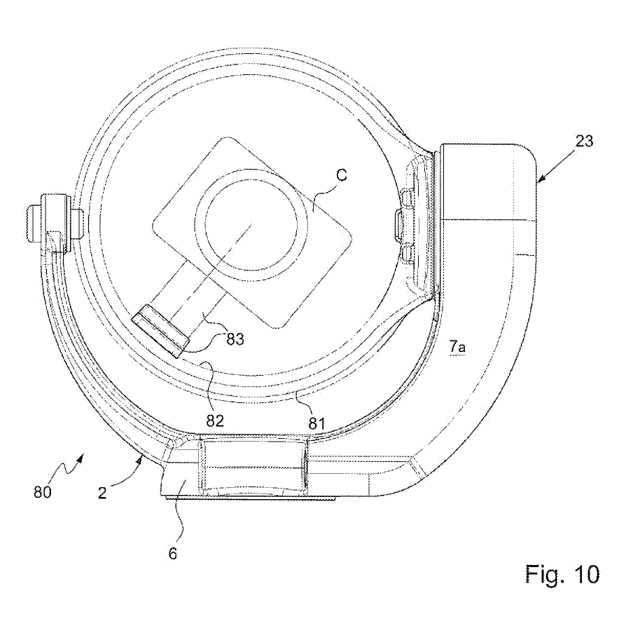

FIG. 10 illustrates by means of essential diagrammatic lines an alternative embodiment of the panoramic head of the present invention, indicated as a whole by 80. Details analogous to those of the preceding figures have a similar structure and are designated by the same reference numbers. In this case it is the second support member 81 which has an annular centre bearing configuration with the definition of an internal circumferential guide 82 on which the third support member 83 is movable, being in the form of a carriage borne on said circumferential guide and rotatable about the third axis through an angle of more than 90° (preferably capable of complete rotations about the third axis). C indicates a camera or other optical apparatus mounted on the head 80. The actuating means are also in this case of the micrometric and motor-driven type. For the remaining characteristics, what has been described with reference to the preceding example is valid.

The invention thus solves the problem posed, at the same time obtaining numerous advantages, including:

the possibility of continuous adjustment of any setting angle, between 0° and 360°, about the axis L

the maintenance of the barycentric positioning of the mounted apparatus and the consequent constancy of the couple required of the motor-driven actuating means, which provides it with actuation with a lower electrical consumption, with homogeneous movements and without load peaks,

the possibility of adjusting the positioning about the axis L while maintaining the focal (optical) axis of the equipment on the subject of the picture,

the possibility of manually positioning the head rapidly by means of the frictioned actuating means, which also act as security against accidental collisions of the movable parts of the head and/or of the apparatus mounted thereon,

the accuracy of the adjustments which is obtained by means of the micrometric actuating means,

the absence of obstacles that can be obtained owing to the reduction of the cables which connect movable parts of the head to fixed parts, all without having recourse to expensive stratagems such as sliding contacts and the like.

1. A panoramic head for photographic and video-photographic equipment, including a first, a second, and at least a third support member, which are articulated in series with one another respectively about a first, a second and at least a third positioning axis (P, T, L), respectively panoramic, azimuthal and level, so as to be positionable in an adjustable manner about said axes (P, T, L) for three-dimensional positioning of the optical axis (X) of photographic or video-photographic equipment mounted on the third member, wherein at least one of the second, and third member, comprises an annular support member, such that the member carried on said annular support, is rotatable about the third axis (L), the annular support member being shaped as a circular closed ring extending around a support the photographic or video-photographic equipment.

2. The panoramic head according to claim 1, wherein said annular support is provided on said third member and is rotatably carried on the second member so as to be rotatable about the third axis (L).

3. The panoramic head according to claim 1, wherein the third axis (L) is disposed so as to coincide, at least approximately, with said optical axis (X).

4. The panoramic head according to claim 1, wherein said support members are mutually articulated with one another in a frictioned manner.

5. The panoramic head according to claim 1, wherein one or more of said support members are kinematically connected to one another via micrometric control actuating means.

6. The panoramic head according to claim 5, wherein the micrometric control actuating means are motor-driven actuating means.

7. The panoramic head according to claim 6, wherein said motor-driven actuating means comprise a closed loop feedback positional control.

8. The panoramic head according to claim 7, wherein said micrometric control actuating means comprise a motor with a corresponding encoder acting on said micrometric control actuating means.

9. The panoramic head according to claim 7, comprising a clutch interposed between said micrometric control actuating means and the axis (P, T, L) which is motor-driven thereby.

10. The panoramic head according to claim 8, wherein said motor-driven actuating means are connected to a remote control unit.

11. The panoramic head according to claim 10, wherein said unit is radio-controlled.

12. The panoramic head according to claim 9, wherein the first support member comprises an element movable about the first axis (P) with respect to a fixed element and wherein said unit and/or a supply battery of the head is/are mounted on board said movable element of the first support member.

13. The panoramic head according to claim 12, wherein on said movable element of the first support member there are also supported the motor-driven actuating means and the positional controls relative to the panoramic (P) and azimuthal (T) axes.

14. The panoramic head according to claim 12, wherein the first support member comprises a first fork forming said movable element and articulated, by a base thereof, intermediate between two opposed first prongs, on the fixed element.

15. The panoramic head according to claim 14, wherein the second support member comprises a second fork, forming a movable element of the second member, and articulated by a base thereof intermediate between two opposed prongs on a fixed element placed at the free end of one of said first prongs.

16. The panoramic head according to claim 15, wherein the third support member comprises a circular annular centre bearing rotatably supported on the second fork.

17. The panoramic head according to claim 16, wherein said centre bearing is actuated via actuating means acting on its outer periphery.

18. The panoramic Panoramic head according to claim 17, wherein said actuating means of the centre bearing comprise a belt drive.

19. The panoramic head according to claim 16, wherein said centre bearing is supported at three points, two of which are at the free ends of the prongs of the second fork and the third is mounted on the member, loaded by springs, which is rotatably supported at the free end of the prong of the first support member opposed to the prong which carries the actuating means thereof.
